(19) United States
(12) Patent Application Publication
(10) Pub. No.: US 2024/0185605 A1
(43) Pub. Date: Jun. 6, 2024

(54) System and Method for Detecting and Explaining Anomalies in Video of a Scene

(71) Applicant: Mitsubishi Electric Research Laboratories, Inc., Cambridge, MA (US)

(72) Inventors: Michael Jones, Belmont, MA (US); Ashish Singh, Amherst, MA (US); Erik Learned-Miller, Amherst, MA (US)

(21) Appl. No.: 18/061,565

(22) Filed: Dec. 5, 2022

(51) Int. Cl. G06V 20/40; G06V 10/62; G06V 10/74; G06V 10/75; G06V 10/82; G06V 20/52

(52) U.S. Cl. CPC G06V 20/44; G06V 10/62; G06V 10/759; G06V 10/761; G06V 10/82; G06V 20/41; G06V 20/48; G06V 20/49; G06V 20/52

(57) ABSTRACT

Embodiments of the present disclosure disclose a method and a system for video anomaly detection. The system is configured to collect a sequence of input video frames of an input video of a scene. In addition, the system is configured to partition each input video frame of the sequence of input video frames into a plurality of input video patches. Further, the system is configured to process each of the plurality of input video patches with one or more classifiers. Each of the one or more classifiers corresponds to a deep neural network trained to estimate one or more attributes of the plurality of input video patches from an output of a penultimate layer of the deep neural network. Furthermore, the system is configured to compare the output of the penultimate layer. The system is further configured to detect an anomaly based on the output of the penultimate layer.

### TECHNICAL FIELD

The present disclosure relates generally to image processing, and more particularly to detecting anomalies and providing explanation of the detected anomalies in video of a scene.

### BACKGROUND

Closed circuit television (CCTV) is widely used for security, surveillance, property monitoring and other purposes. Example applications of the CCTV include the observation of crime or vandalism in public open spaces or buildings (such as hospitals and schools), intrusion into prohibited areas, monitoring the free flow of road traffic, detection of traffic incidents and queues, detection of vehicles travelling the wrong way on one-way roads, and the like.

The monitoring of CCTV displays (by human operators) is a very laborious task, however, and there is considerable risk that events of interest may go unnoticed. This is especially true when operators are required to monitor a number of CCTV camera outputs simultaneously. As a result, in many CCTV installations, video data is recorded and only inspected in detail if an event is known to have taken place. Even in these cases, the volume of recorded data may be large, and the manual inspection of the data may be laborious. Consequently, there is a need for automatic devices to process video images to detect when there is an event of interest. Such detection is referred to herein as video anomaly detection and can be used to draw the event to the immediate attention of an operator, to trigger an action in response to the anomaly, to place an index mark in recorded video and/or to trigger selective recording of CCTV data.

The problem of video anomaly detection is to automatically detect activity in part of a video that is different from activities seen in normal video of the same scene. For example, the video may be of a street scene with people walking along a sidewalk. Anomalous activity to be detected might be people fighting or climbing over a fence, or a car driving on the sidewalk.

There have been various approaches to the video anomaly detection problem that have been studied in the literature. For example, one approach uses a convolutional neural network auto-encoder trained on a particular scene or set of scenes to reconstruct frames of the nominal video. The idea is that the auto-encoder learns to reconstruct frames that are normal with low error but will have higher reconstruction error on anomalous frames. To detect anomalies, the auto-encoder is used to reconstruct frames of the testing video. Frames with high reconstruction error are flagged as anomalous. Another similar idea performs prediction of a future frame of a video from past frames using a neural network. Again, the basic idea is that the trained neural network will be able to predict future frames for normal video on which it was trained but will have larger reconstruction error for frames with anomalies.

Another line of work for video anomaly detection is based on tracking the pose (meaning joint positions and angles) of people in video using human skeleton models. In this approach, a model of normal human skeleton poses and motions are learned from video containing only normal human activity. Anomalies are detected by noticing novel human skeleton poses or motions in test video. The main drawback of these approaches is that they can only detect anomalies involving humans. Anomalies involving any other object classes cannot be detected with this approach.

Another previous method for video anomaly detection was described in U.S. Pat. No. 10,824,935. In that method, a function (such as a Siamese neural network) optimized using machine learning was used to compare video patches. This was applied to the problem of video anomaly detection by first storing a set of normal video patches for a scene (taken from normal video of the scene) and then comparing test video patches from new video of the same scene using the Siamese neural network. Test video patches that are not similar to any normal video patches must be anomalous. The main drawback of this approach is that the features learned by the Siamese neural network that are used to compare video patches are not human interpretable. This means that using the method of U.S. Pat. No. 10,824,935, it is not possible to provide an explanation for why a particular anomaly is anomalous. That method only knows that an anomaly has occurred but cannot explain why.

None of the previous work provides a general method for detecting any type of anomaly as well as a human-understandable explanation for each anomaly that is detected. For example, the system may detect an anomaly because its reconstruction of the current frame has high error. The system does not know why the reconstruction error is high. It does not have an explanation for what caused the high reconstruction error.

Accordingly, there is still a need for a system and a method for detecting anomalies in the input video that is capable of providing a human-understandable explanation of “why” a certain activity in a scene is anomalous.

### SUMMARY

In order to solve the foregoing problem, it is an objective of some embodiments to compare high-level features estimated from neural networks of normal video to high-level features of input video from the same scene to detect anomalies. Hereinafter, ‘normal video’ and ‘nominal video’ may be interchangeably used to mean the same. As used herein, ‘nominal video’ may correspond to a video that includes a set of video frames corresponding to normal activity in the video scene.

The system splits an input video into a plurality of spatial regions. A spatial region may be defined by a rectangle with a particular height and width in terms of pixels. The plurality of spatial regions may be overlapping. Furthermore, the nominal video is partitioned into video patches by sliding a three-dimensional window along a temporal dimension for each spatial region. For instance, each video patch includes spatial dimensions equal to the dimensions of the spatial region and a temporal dimension specifying the number of video frames in the video patch.

In addition, the system is configured to learn a set of “high-level” attributes or features that represent appearance and motion features present in the video patch. For example, high level attributes could consist of object classes present in the video patch (car, person, bicycle, and the like), directions of motion for objects moving in the video patch, and speeds of motion for objects moving in the video patch. A high-level attribute may be estimated directly from the video patch using a deep neural network.

A deep neural network contains an input layer (containing a video patch), multiple hidden layers and an output layer (the high-level attribute). A deep neural network has a second-to-last layer known as a penultimate layer whose output consists of a high-level feature vector which is mapped to a high-level attribute of the nominal video. The term “high-level attribute” is used to mean a human-interpretable attribute of the video patch such as the set of object classes that appear in the video patch, or the directions of motion of the objects that appear in the video patch, etc. The term “high-level feature” is used to mean an internal representation of a classifier or a deep neural network trained using machine learning. The high-level features may be mapped to high-level attributes using a classifier or deep neural network.

In one embodiment, the system is configured to generate a set of exemplars for each spatial region of the nominal video. An exemplar is a set of high-level features from the penultimate layers of deep neural networks trained to estimate high-level appearance or motion attributes. The set of exemplars for a particular spatial region in the nominal video represents all the high-level feature vectors seen in that spatial region considering all video patches occurring in that spatial region of the nominal video. In other words, the set of exemplars for a spatial region represents all of the normal activity that occurs in the nominal video in that spatial region.

Further, to detect anomalies in an input or testing video of a scene, the testing video is partitioned into the same spatial regions in the same way as the nominal video. The video patches are extracted by scanning along the temporal dimension for each spatial region as done for the nominal video. The high level features are computed by the deep neural network for each test video patch. The high-level features are compared to each exemplar stored for the corresponding spatial region. Furthermore, the system is configured to assign an anomaly score to the test video based on the comparison. The anomaly score assigned to the test video patch is the minimum distance of the high-level features for that video patch to each of the exemplars for the corresponding spatial region. The anomaly score is less if the high-level features are close to at least one exemplar and further indicates that there is no anomaly in the video patch. The anomaly score is more if the high-level features are far from all exemplars and thus indicates that the video patch is anomalous.

If a video patch is found to be anomalous, the system can provide an explanation by finding which of the high-level features did not match well with the high-level features of the closest exemplar. The system provides the explanation by mapping those high-level features to the corresponding high-level attributes using the final layers of the deep neural networks and indicating that the test video patch differs from normal activity in terms of the non-matching high-level attributes. For example, if the high-level attributes represent object classes and directions of motion, then the explanation of an anomaly could be that the test video patch contained an unexpected object or that it contained an object moving in an unexpected direction.

Accordingly, one embodiment discloses a system for video anomaly detection and explanation. The system includes a processor; and a memory. The memory stores instructions which when executed by the processor cause the system to collect a sequence of input video frames of an input video of a scene. The system is further configured to partition each input video frame of the sequence of input video frames into a plurality of input video patches. Each of the plurality of input video patches is a spatio-temporal patch. Furthermore, the system is configured to process each of the plurality of input video patches with one or more classifiers. Each of the one or more classifiers corresponds to a deep neural network having an output layer trained to estimate one or more attributes of the plurality of input video patches from an output of a penultimate layer of the deep neural network. Moreover, the system is configured to compare the output of the penultimate layer of the one or more classifiers generated using the plurality of input video patches with corresponding nominal outputs of the penultimate layer of the one or more classifiers generated using corresponding nominal video patches. A nominal video patch of the corresponding nominal video patches and an input video patch of the plurality of input video patches correspond to the same spatial region. The output of the penultimate layer of a particular classifier of the one or more classifiers processing the corresponding nominal video patch and the input video patch are corresponding to each other. In addition, the system is configured to detect an anomaly when the output of the penultimate layer of the particular classifier is dissimilar to the corresponding nominal outputs of the penultimate layer of the particular classifier. Also, the system is configured to provide an output comprising an explanation of a type of the detected anomaly. The output is provided based on the dissimilarity of the penultimate layer outputs between the input video patch and the closest matching nominal video patch from the same spatial region.

To that end, each of the plurality of input video patches has a spatial dimension defining a spatial region of the spatio-temporal patch in each of the sequence of input video frames and a temporal dimension defining a number of input video frames forming the spatio-temporal patch.

In some embodiments, the nominal video patches are generated by partitioning training sequence of nominal video frames. The nominal video corresponds to video of normal activities happening in the same scene as the input video.

To that end, the deep neural networks are trained using video that is distinct from the nominal video used to learn an exemplar-based model of a particular scene. The sources of nominal video for the deep neural networks could be from: surveillance cameras installed at the one or more locations.

In some embodiments, the spatio-temporal partitions of the input video are identical to the spatio-temporal partitions of the nominal video to streamline the comparison.

To that end, the system is configured to compare the output generated by the penultimate layer of the one or more classifiers with the corresponding nominal outputs using one or more algorithms associated with nearest neighbor search, wherein the one or more algorithms corresponds to such as: brute force search, k-d trees, k-means trees, locality sensitive hashing, and the like.

In some embodiments, the one or more attributes of the input video patch comprises appearance and motion attributes. The appearance and motion attributes comprises such as: object classes, directions of motion for objects in the input video patch, speed of motion in each direction, and size of moving objects in the input video patch, and the like.

Accordingly, another embodiment discloses a method for performing video anomaly detection. The method includes collecting a sequence of input video frames of an input video of a scene. The method further includes partitioning the sequence of input video frames into a plurality of input video patches. Each of the plurality of input video patches is a spatio-temporal patch defined in space and time. The method includes processing each of the plurality of input video patches with one or more classifiers. Each of the one or more classifiers corresponds to a deep neural network having an output layer trained to estimate one or more attributes of the plurality of input video patches from an output of a penultimate layer of the deep neural network. Furthermore, the method includes comparing the output of the penultimate layer of the one or more classifiers generated using the plurality of input video patches with corresponding nominal outputs of the penultimate layer of the one or more classifiers generated using corresponding nominal video patches. The nominal video patch of the corresponding nominal video patches and an input video patch of the plurality of input patches correspond to the same spatial region. The outputs of the penultimate layer of a particular classifier of the one or more classifiers processing the corresponding nominal video patch and the input video patch are corresponding to each other. Also, the method includes detecting an anomaly when the output of the penultimate layer of the particular classifier is dissimilar to the corresponding nominal outputs of the penultimate layer of the particular classifier. The method includes providing an output comprising explanation of a type of the detected anomaly. The output is provided based on the one or more attributes of the input video patch estimated by the output layer of the particular classifier using the dissimilar output of the penultimate layer of the closest matching nominal video patch.

### BRIEF DESCRIPTION OF THE DRAWINGS

FIG. 1A illustrates a flow chart depicting stages of detecting anomalies in an input video of a scene, in accordance with various embodiments.

FIG. 1B illustrates a block diagram of an environment for detecting anomalies in an input video of a scene, in accordance with various embodiments.

FIG. 1C illustrates a block diagram of a system for detecting anomalies in the input video of the scene, in accordance with various embodiments.

FIG. 2 illustrates an example of partitioning a sequence of input video frames into a set of spatio-temporal patches, in accordance with various embodiments.

FIG. 3 is an example of architecture of a deep neural network used in anomaly detection, in accordance with various embodiments.

FIG. 4A illustrates a diagram of a set of deep neural networks to estimate high-level attributes from a single video patch, in accordance with various embodiments.

FIG. 4B illustrates a schematic for selecting a set of exemplars using outputs of one or more deep neural networks evaluated on a set of nominal video patches, in accordance with various embodiments.

FIG. 5 illustrates a schematic diagram of a nearest neighbor search algorithm to find closest exemplar to high-level features of an input video patch, in accordance with various embodiments.

FIG. 6 illustrates a flow chart of a method for anomaly detection, in accordance with various embodiments.

FIG. 7 illustrates a block diagram of a computer-based system for detecting anomalies in an input video, in accordance with various embodiments.

FIG. 8 illustrates a use case of the system for detecting a cyclist as an anomaly on a sidewalk of a street, in accordance with various embodiments.

FIG. 9 illustrates a use case of the system for detecting jaywalkers on in a street scene, in accordance with some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure. Contemplated are various changes that may be made in the function and arrangement of elements without departing from the spirit and scope of the subject matter disclosed as set forth in the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

It is an object of some embodiments to divide the input video into overlapping spatial regions and compare each of the spatial regions of the input video with the corresponding region in the nominal video for anomaly detection using a system with facilitation of deep neural networks. The deep neural network based systems can process complex data inputs. Such systems “learn” to perform tasks by considering examples, generally without being programmed with any task-specific rules. To that end, it is advantageous to provide such a system for direct comparison of activities in input and nominal videos for automatic anomaly detection.

In addition, it is the object of some embodiments to provide human-interpretable explanations for anomaly detection. The system learns a set of “high-level” attributes that represent the appearance and motion attributes present in a video patch. For example, high level attributes could consist of the object classes present in the video patch (car, person, bicycle, etc.), directions of motion for objects moving in the video patch, and speeds of motion for objects moving in the video patch. A high-level attribute is estimated directly from a video patch using the deep neural network (or other classification or regression method).

### System Overview

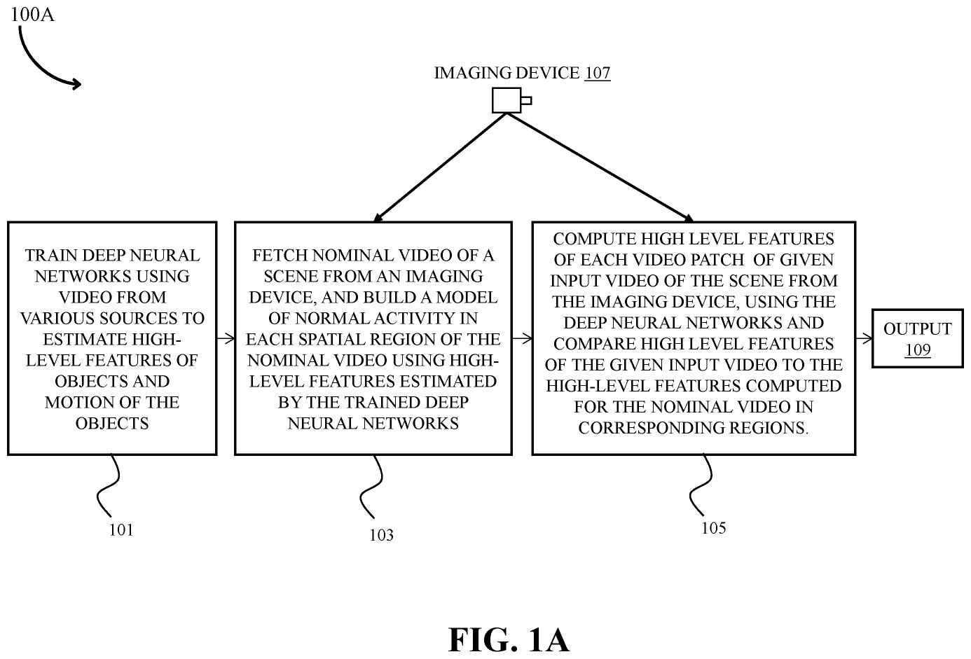

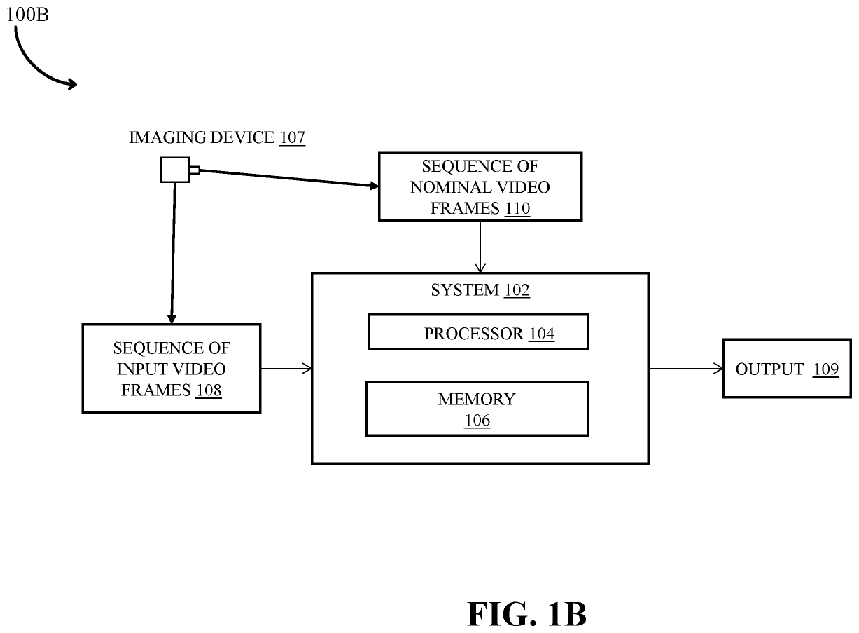

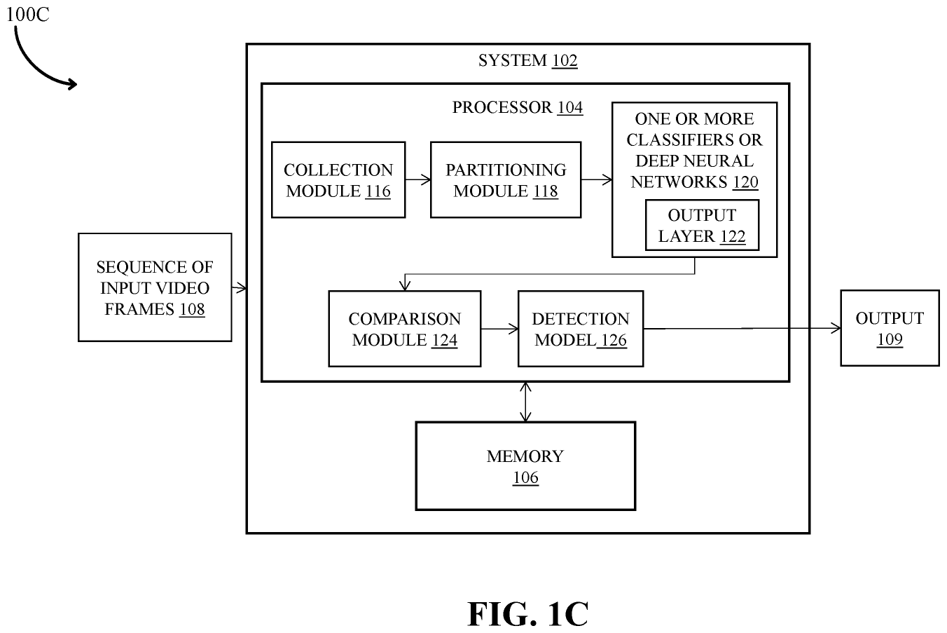

FIG. 1A illustrates a flow chart 100A depicting stages of detecting anomalies in an input video of a scene, in accordance with various embodiments. At stage 101, one or more deep neural networks are trained using video captured from various sources to estimate high-level features of objects and motion of objects. In an example, the objects include but may not be limited to car, person, bicycle, tree, house, dog and the like. Generally, deep neural networks have various network architectures, but always include a second-to-last (penultimate) layer that outputs a feature vector that is mapped to an output layer. The output layer represents the high-level features that are human-interpretable and serve as descriptors for the appearance and motion content of the video. The one or more deep neural networks are trained only once and are not specific to a particular scene.

At stage 103, a nominal video of a scene is fetched from an imaging device 107 to build an exemplar-based model. The exemplar-based model is a model of normal activity in each spatial region of the nominal video using high level features estimated by the trained one or more deep neural networks. The nominal video of the scene is captured by the imaging device 107 that is stationary. The nominal video is partitioned into possibly overlapping spatial regions and for each spatial region a fixed-length temporal window is slid along the temporal dimension to generate video patches. In addition, the trained one or more deep neural networks compute a set of high-level feature vectors for each video patch. A subset of the sets of high-level feature vectors for each of the video patches of a spatial region is selected as the exemplar set for that spatial region. The sets of high-level feature vectors for each video patch forms the exemplar-based model of the nominal video.

At stage 105, the exemplar-based model built in the stage 103 is utilized to detect anomalies in an input video of the scene captured by the same stationary imaging device 107 used in the stage 103. The input video is partitioned into the same spatial regions used for the nominal video in the stage 103. A fixed-length temporal window is slid along the temporal dimension to generate video patches for each spatial region. For each video patch, of the given input video, high level features are computed, using the one or more deep neural networks. Further, the high level features of the given input video are compared with the high-level features computed for the nominal video in corresponding region and an output 109 is generated. In an example, for each video patch, the one or more deep neural networks are used to compute a set of high-level feature vectors. For each set of high-level feature vectors, the closest exemplar is found and a distance between the set of high-level feature vectors for the input video patch and the closest exemplar is computed. If the distance is higher than a threshold, an anomaly is detected as the output 109. Also, an explanation for the anomaly is formed by computing the high-level features, determining high-level features that have higher distances, and mapping these with non-matching high-level features of high-level attributes. The high-level attributes of the non-matching high-level features indicate anomalous part of the video patch.

FIG. 1B illustrates an environment 100B for detecting anomalies in the input video, in accordance with various embodiments. The environment 100B includes a system 102, a sequence of input video frames 108, a sequence of nominal video frames 110, and the imaging device 107.

The system 102 includes a processor 104, and a memory 106. The memory 106 comprises at least one of RAM, ROM, EEPROM, flash memory or other memory technology, CD-ROM, digital versatile disks (DVD) or other optical disk storage, magnetic cassettes, magnetic tape, magnetic disk storage, or any other storage medium which can be used to store the desired information, and which can be accessed by the system 102. The memory 106 may include non-transitory computer-storage media in the form of volatile and/or nonvolatile memory. The memory 106 may be removable, non-removable, or a combination thereof. Exemplary memory devices include solid-state memory, hard drives, optical-disc drives, and the like. The memory 106 stores instructions which are executed by the processor 104. The execution of the instructions by the processor 104 cause the system 102 to perform a set of actions explained below.

The system 102 is configured to collect the sequence of input video frames 108 of the input video of a particular scene. The input video is received from the imaging device 107. The imaging device 107 includes but may not be limited to a video camera. The imaging device 107 is a stationary video capturing device. In an embodiment, the input video is received in real time from the imaging device 107. The imaging device 107 may be present anywhere in the environment 100B or connected to the system 102 through a communication network.

The system 102 partitions each input video frame of the sequence of input video frames 108 of the input video into a plurality of input video patches. Further, the system is configured to receive the sequence of nominal video frames 110 from the same imaging device 107 from which the input video is received. The sequence of nominal video frames 110 includes one or more nominal videos. Each nominal video of the one or more nominal videos corresponds to a video of normal activities happening at the same location as the input video. The nominal videos are processed to build the exemplar-based model of normal activity (as explained in FIG. 1A). The system 102 is configured to process the plurality of input video patches and compares each of the plurality of input video patches with the exemplars learned from the nominal videos to detect an anomaly in the input video. Furthermore, the system 102 is configured to provide the output 109. The output 109 includes detection of an anomaly and an explanation of a type of the detected anomaly.

FIG. 1C illustrates a block diagram 100C of the system 102 for detecting anomalies in the input video of the scene, in accordance with various embodiments. The system 102 includes the processor 104, and the memory 106. The processor 104 is associated with the memory 106 (as explained above in FIG. 1A). The memory 106 stores instructions which are executed by the processor 104. The execution of the instructions by the processor 104 cause the system 102 to perform a set of actions explained below.

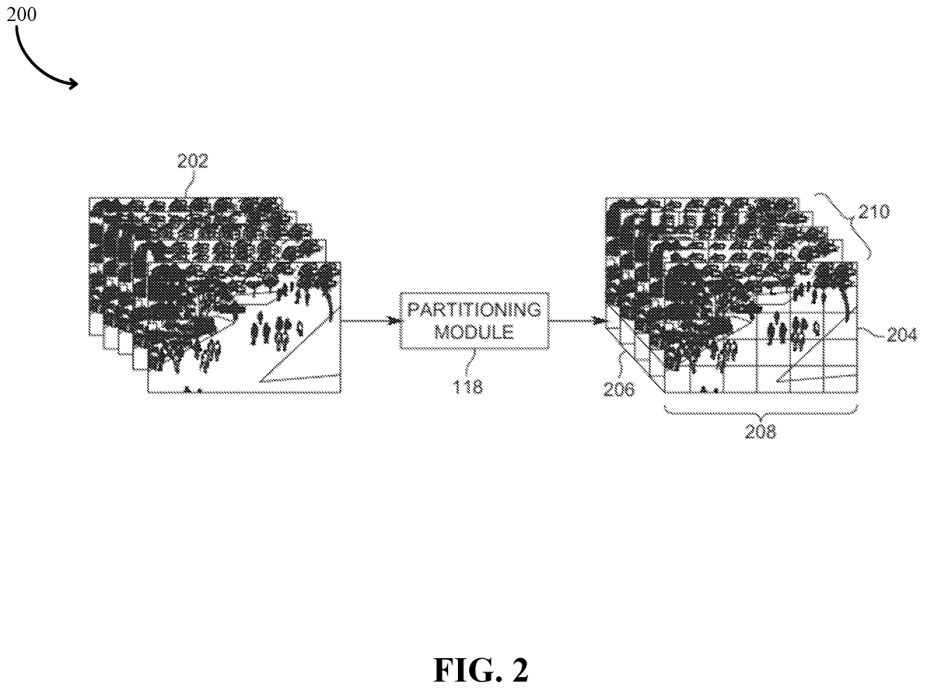

The processor 104 of the system 102 includes a collection module 116, a partitioning module 118, one or more classifiers (or equivalently deep neural networks) 120, a comparison module 124, and a detection module 126. The system 102 collects the sequence of input video frames 108 of the input video with facilitation of the collection module 116. The collection module 116 is configured to collect the sequence of input video frames. For example, the collection module 116 may be communicatively coupled to or encompass an I/O interface for receiving and/or sending data inputs to and/from the system 102. The collection module 116 further sends the sequence of input video frames to the partitioning module 118. The partitioning module 118 is configured to partition the sequence of input video frames 108 into the plurality of input video patches. Each of the plurality of input video patches is a spatio-temporal patch (explained in detail in FIG. 2).

Each input video patch of the plurality of input video patches is then sent to the one or more classifiers 120. The one or more classifiers 120 process each of the plurality of input video patches. Each of the one or more classifiers 120 corresponds to a deep neural network having an output layer 122. The output layer 122 of the deep neural network is trained to estimate one or more attributes of the plurality of input video patches from an output of a penultimate layer of the deep neural network.

In general, a neural network includes an input layer, one or more hidden layers, and an output layer. The output layer 122 is computed from the penultimate layer of the deep neural network which it is connected to. In addition, the penultimate layer is the last layer in the hidden layers of the deep neural network. The output from the penultimate layer corresponds to a feature vector that can be mapped to the one or more attributes of the video patch. The neural network is trained such that its output layer 122 estimates the one or more attributes of its input video patch. The one or more attributes of the input video patch of the plurality of input video patches corresponds to appearance and motion attributes. The appearance and motion attributes comprise at least one of: object classes present in the plurality of input video patches, directions of motion for objects in each of the plurality of input video patches, speed of motion in each direction, and size of moving objects in the plurality of input video patches.

Further, the system 102 utilizes the comparison module 124. The comparison module 124 is configured to compare the output of the penultimate layer of the one or more classifiers 120 generated using the plurality of input video patches with the corresponding nominal output of the penultimate layer of the one or more classifiers 120 generated using training a plurality of nominal video patches. Each of the plurality of nominal video patches and the input video patch of the plurality of input video patches correspond to the same spatial region of the scene. The output of the penultimate layer of a particular classifier of the one or more classifiers 120 processing the corresponding nominal video patch and the input video patch are corresponding to each other. The plurality of nominal video patches for each spatial region are a subset of every possible video patch in the sequence of nominal video frames 110 and are chosen to cover the entire set of nominal video patches.

The comparison of the output of the penultimate layer of the one or more classifiers 120 generated using the plurality of input video patches with the corresponding the nominal output of the penultimate layer using the plurality of nominal video patches is utilized by the detection model 126. The detection model 126 is configured to detect an anomaly when the output of the penultimate layer of the particular classifier of the one or more classifiers 120 is dissimilar to the corresponding nominal output of the penultimate layer of the particular classifier.

Furthermore, the detection model 126 provides the output 109. The output 109 includes explanation of a type of the detected anomaly. The output 109 is provided based on the one or more attributes of the input video patch estimated by the output layer of the particular classifier using the dissimilar output of the penultimate layer of the particular classifier for the closest matching exemplar. In an example, “an input video includes a cyclist at location A, but the nominal video never contained a cyclist at the location A”. The detection model 126 detects an anomaly in the input video and provides explanation that, “the anomaly is detected due to presence of the cyclist at the location A, which is unusual”.

FIG. 2 illustrates an example 200a of spatio-temporal partitions of a sequence of video frames of a video 202 into a set of spatio-temporal patches 204, in accordance with various embodiments. The sequence of video frames of the video 202 is fed into the partitioning module 118 as input. The partitioning module 118 partitions each video frame of the sequence of video frames into the set of spatio-temporal patches 204. Each spatio-temporal patch, for example, a video patch 206, is defined in space and time by a spatial dimension 208 defining a region of the spatio-temporal patch in each video frame and a temporal dimension 210 defining a number of video frames forming the spatio-temporal patch 206. The set of spatio-temporal patches 204 is overlapping in the spatial dimension 208 and the temporal dimension 210. In one embodiment, the video 202 is an input video. In second embodiment, the video 202 is a nominal video. As used herein, a nominal video patch and an input video patch of a same region are corresponding to each other.

Various embodiments use different spatio-temporal partitions of the video 202 to define the set of spatio-temporal patches 204. Further, the set of spatio-temporal patches 204 are utilized by a deep neural network, such as the deep neural network 120 shown in FIG. 1B, for estimating the one or more attributes of each spatio-temporal patch of the set of spatio-temporal patches 204. However, in various implementations, the spatio-temporal partitions of the input video are identical to the spatio-temporal partitions of the nominal video so that the outputs of the penultimate layer of the one or more classifiers 120 are comparable.

Each of the plurality of input video patches is processed using the one or more deep neural networks 120. The one or more deep neural networks 120 extract the high level features of each of the plurality of input video patches. The high level features correspond to the one or more attributes, such as an object class, direction of motion, and a speed. The one or more attributes mentioned are for example purpose only, and by no means should be construed to be limiting the scope of the present disclosure. Some embodiments are based on the realization that detecting anomalous parts of any input video can be accomplished by comparing the high-level features of each of the plurality of input video patches (i.e. each spatio-temporal region) to high-level features of all of the normal nominal videos within the same spatial region. It is important to compare the input video to the normal nominal video within the same spatial region as the normal activity depends on location. For example, a person walking along a sidewalk is normal, but a person walking in the middle of the street or on top of a building is usually anomalous.

In an example, the system 102 is configured to assign an anomaly score to an input or test video. In an example, the anomaly score assigned to the test video patch is the minimum distance of the high-level features for that video patch to each of the exemplars for the corresponding spatial region. An exemplar is a set of high-level features from the penultimate layers of the deep neural network 120 trained to estimate high-level appearance or motion attributes. The set of exemplars for a particular spatial region in the normal video represents all the high-level feature vectors seen in that spatial region considering all video patches occurring in that spatial region of the nominal video. In other words, the set of exemplars for a spatial region represent all of the nominal activity that occurs in the nominal video in that spatial region. The anomaly score is less if the high-level features of the input video is close to at least one exemplar (high-level feature of the nominal video) and further indicates that there is no anomaly in the given input video. The anomaly score is more if the high-level features of the input video are far from all exemplars (high level features of the nominal video) and thus indicates that the input video is anomalous.

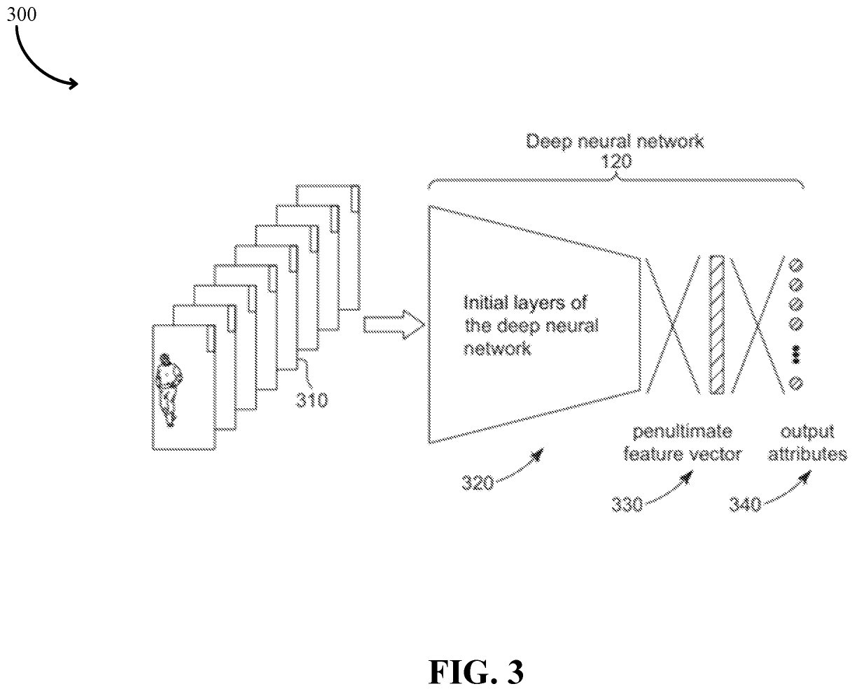

FIG. 3 is an example of the deep neural network 120 that estimates the high-level attributes of an input video patch 310, in accordance with various embodiments. The deep neural network 120 is trained to estimate high-level attributes 340 that includes but is not limited to appearance attributes, and motion attributes from a spatio-temporal patch. As an example, a high-level attribute can consist of a vector of probabilities representing the likelihood that each of a fixed set of object classes exist in the spatio-temporal patch. As another example, the high-level attribute corresponds to a vector representing the fraction of pixels in the spatio-temporal patch moving in each of a fixed set of directions. The deep neural network 120 takes as input a spatio-temporal video patch 310 and outputs a vector representing the high-level attributes 340. The deep neural network 120 has a body 320. The body 320 of the deep neural network 120 may consist of multiple initial layers including 2D convolution layers, 3D convolution layers, pooling layers, nonlinear activation layers, fully connected layers and the like. The result of the initial layers is a penultimate feature vector 330. The penultimate feature vector 330 represents some high-level features of the spatio-temporal video patch 310. The penultimate feature vector 330 is mapped through a final fully connected layer (computed by a simple matrix multiplication) to the high-level attributes that are human-understandable attributes 340. The deep neural network 120 is trained using the videos that are captured from various sources and are independent of the scenes that may be involved in video anomaly detection. The deep neural network 120 is trained for estimating the high-level attributes present in any spatio-temporal video patch.

Some embodiments are based on the realization that if the high-level features of the input video patch 310 can be mapped to the one or more attributes that are human-understandable then the system 102 can provide human-understandable explanations for its decisions. In addition, the penultimate feature vector 330 of the deep neural network 120 is used as the high-level features. Further, an explanation consists of the high-level attributes corresponding to the high-level features of an input video patch that have large distance to the closest matching exemplar in the set of exemplars learned from nominal video for the same spatial region of the input video patch. In one embodiment, the penultimate feature vector 330 computed from the deep neural network 120 for two different video patches are compared using the Euclidean distance.

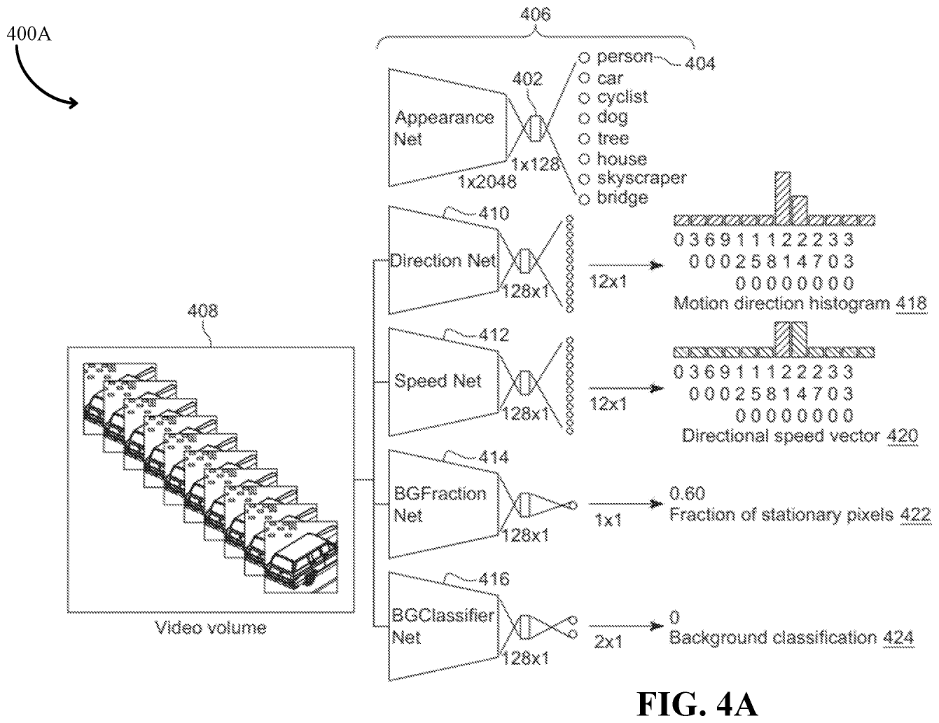

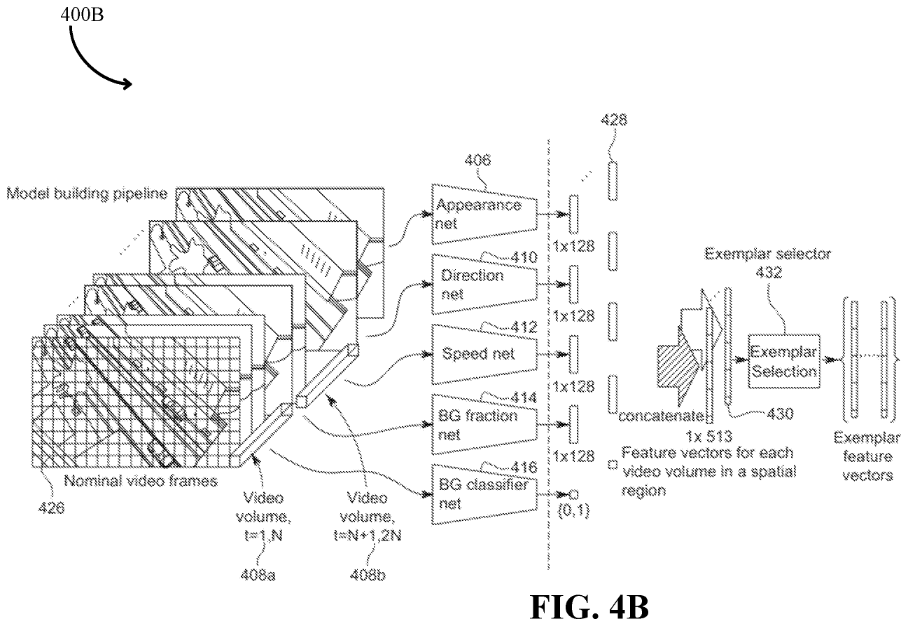

FIG. 4 illustrates a block diagram of estimating a set of high-level attributes of a single video patch 408 from one or more deep neural networks 120. In an example, 5 different deep neural networks are shown, such as: a deep neural network 406, a deep neural network 410, a deep neural network 412, a deep neural network 414, and a deep neural network 416. Each deep neural network outputs a different high-level attribute of the single video patch 408. The one or more deep neural networks 120 includes such as the appearance network 406, the direction network 410, the speed network 412, the background fraction network 414, and the background classifier network 416.

In the example, the appearance network 406 corresponds to an object class deep neural network. The object class deep neural network outputs 404 the likelihood that the input video patch 408 contains one of 8 object classes such as person, car, bicycle, dog, tree, house, skyscraper, or bridge.

In addition, the direction network 410 is trained to output the motion direction histogram 418. The motion direction histogram is a histogram of optical flow. The histogram of optical flow consists of 12 bins each of which stores the fraction of pixels in the video patch 408 that are estimated to be moving in one of the 30 degree directions of motion.

The speed network 412 is trained to output the directional speed vector 420. The directional speed vector 420 is a vector of average speed of pixels in each direction of motion. The directional speed vector 420 consists of the average speed (in pixels per frame) of all pixels falling in each of the 12 histogram of flow bins.

The background fraction network 414 is trained to output the fraction of stationary pixels 422. The fraction of stationary pixels 422 in the video patch 408 gives a rough size of the moving objects in the video volume 408

The background classifier network 416 is trained to output the background classification 424 of the video patch 408. The background classification classifies whether the video volume 408 contains motion or not.

The high-level features, such as a feature 402 outputted from each deep neural network yield a set of high-level features.

FIG. 4B illustrates a block diagram 400B of selecting a set of exemplars to model the activity that is present in a nominal video frame. An exemplar is a set of high-level feature vectors computed from a single video patch using the penultimate layer outputs of the previously trained one or more deep neural networks 120. Once the deep neural networks 120 are trained, the system 102 utilizes them to represent nominal video. As illustrated in FIG. 4B, to process each of a plurality of nominal video frames 426, a spatio-temporal patch of dimension [h×w×t] with spatial stride (r, c) and temporal stride of s is defined to construct video volumes 408a, 408b.

In an example, it is assumed that h=w and h is approximately the height in pixels of a person in a particular dataset. For each video volume 408a, 408b, the system 102 extracts the high-level features using the previously trained deep neural networks, such as the deep neural network 406, the deep neural network 410, the deep neural network 412, the deep neural network 414, and the deep neural network 416 (hereinafter also referred to interchangeable as the deep neural networks 406-416). The system 102 concatenates feature vectors 428 extracted from the penultimate layer of the deep neural networks 406-416 to create combined feature vectors 430 for each video volume 408a, 408b of the nominal video frames 426.

The feature vectors 428 extracted from the penultimate layer of the trained deep networks 406-416 are represented as “F” to denote the combined feature vectors 430 and “app”, “ang”, “mag”, and “bkg” are used to denote the appearance attribute, an angle attribute, magnitude attribute and background pixel fraction feature vectors respectively, each of size 1×128. Finally, “cls” denotes the binary background classification of size 1×1. F having a size of 1×513.

After computing the feature vectors 430, the system 102 utilizes the exemplar selection approach using an exemplar selector 432 to create a region-specific compact model of the nominal data. For each region, the system 102 uses the following greedy exemplar selection algorithm: 1.) Add the first feature vector to the exemplar set, and 2.) For each subsequent feature vector, compute its distance to each feature vector in the exemplar set and add it to the exemplar set only if all distances are above a threshold, th. To compute the distance between two feature vectors F1=[app1; ang1; mag1; bkg1; cls1] and F2=[app2; ang2; mag2; bkg2; cls2], the system 102 uses L2 distances between corresponding components normalized by a constant to make the maximum distance for each component approximately 1.

In an example, when a video volume does not have any motion, motion components become meaningless and motion feature vectors (ang, mag, bkg) are set to zero vectors.

The distance function can be written as follows:

$${d}_{a p p} ( F 1 , F 2 ) = {‖ app 1 - app 2 ‖}_{2} ,$$

$${d}_{ang} ( F 1 , F 2 ) = {‖ ang 1 - ang 2 ‖}_{2} ,$$

$${d}_{bkg} ( F 1 , F 2 ) = {‖ bkg 1 - bkg 2 ‖}_{2} ,$$

$${d}_{mag} ( F 1 , F 2 ) = {‖ mag 1 - mag 2 ‖}_{2.}$$

$$d ( F 1 , F 2 ) = \frac{{d}_{app}}{{Z}_{app}} + \frac{{d}_{ang}}{{Z}_{ang}} + \frac{{d}_{mag}}{{Z}_{mag}} + \frac{{d}_{bkg}}{{Z}_{bkg}}$$

The normalization factors, Zₐₚₚ, Z_{ang}, Z_{mag} and Z_{bkg} are computed once by finding the max L₂ distances between a large set of feature vector components.

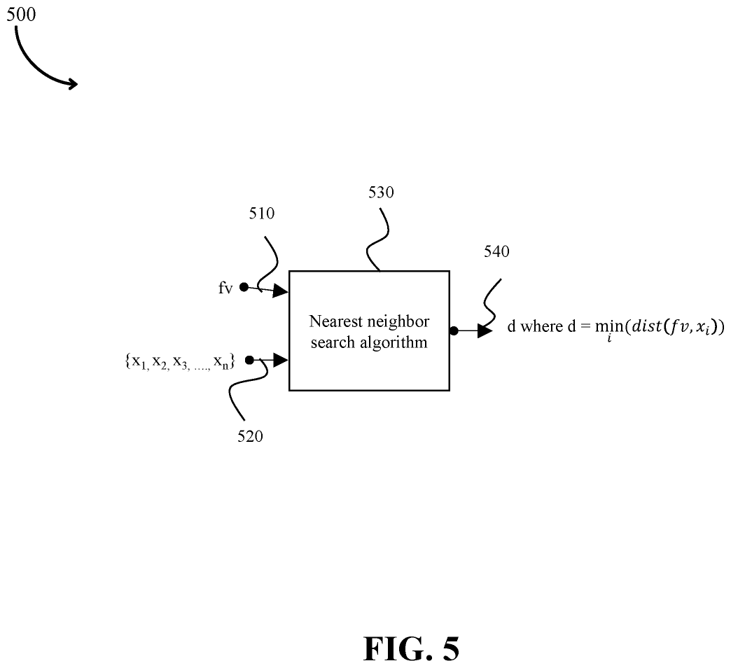

FIG. 5 shows a schematic diagram 500 of a nearest neighbor search algorithm 530 to find the closest exemplar to high-level features of an input video patch, in accordance with various embodiments of the present disclosure. In FIG. 5, f, is a high-level feature vector 510 of an input video patch and each xi (x₁, x₂, x₃, . . . , xₙ) 520 is a high-level feature vector for a nominal video patch (exemplar). A nearest neighbor search algorithm 530 outputs a minimum distance, d, 540 between f, 510 and the nearest xᵢ 520. If the minimum distance, d, 540 is higher than a threshold of the anomaly score, then it is indicated that the input video patch has an anomaly.

Different embodiments use different distance functions between high-level features. In one embodiment, Euclidean distance function is utilized. The nearest neighbor search algorithm may include different search algorithms. For example, one embodiment uses brute force search algorithm to compare each input feature vector f, 510 with each nominal feature vector xᵢ 520. In some implementations, the nearest neighbor search algorithm 530 is an approximate nearest neighbor search algorithm, which is not guaranteed to find the minimum distance but may instead find a feature vector that is close to the minimum. Various nearest neighbor search algorithms known in the field could be used such as k-d trees, k-means trees, and locality sensitive hashing.

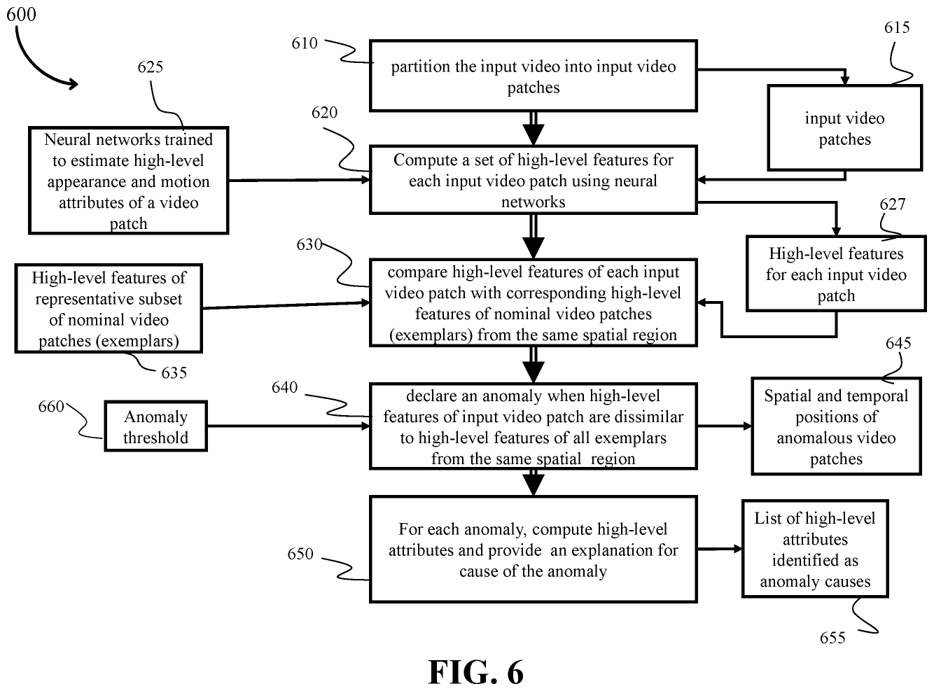

FIG. 6 illustrates a flow chart 600 of a method for anomaly detection, in accordance with various embodiments. The method can be executed by the processor 104 of the system 102 according to instructions stored in the memory 106. At step 610, the method 600 includes partitioning of an input video into input video patches 615. The input video patches 615 corresponds to the plurality of video patches explained above in FIG. 1A, FIG. 1B, and FIG. 2. A video patch is a spatio-temporal region that can be defined by a bounding box in a video frame defining spatial extent and a fixed number of frames, defining temporal extent (explained earlier in FIG. 2). Hence, pixels of a video within a spatio-temporal region comprise a video patch. Different video patches may be overlapping. The union of all video patches covers the entire video sequence.

At step 620, the method 600 uses one or more neural networks 625 to estimate high-level features 627 for each of the input video patches. The one or more neural networks 625 correspond to the deep neural network 120 of FIG. 1C. The one or more neural networks 625 is trained to estimate the high level appearance and motion attributes of each of the input video patches 615 as explained above in FIG. 3, FIG. 4A and FIG. 4B. At step 630, each of the high-level features 627 is compared with high-level features 635 (called exemplars) of nominal video patches from the same spatial region as the high-level features from the input video patch. The corresponding exemplars are retrieved from the memory 106 and compared to high-level features of the input video patch using the distance function such as Euclidean distance between each high-level feature as discussed in FIG. 4B.

At step 640, the method 600 includes detection of an anomaly when the high-level features 627 for the input video patch 615 have large distance to the closest exemplar 635 for that spatial region. In addition, the method 600 detects the anomaly, if the distance between the high-level features 627 for the input video patch 615 and the closest of the exemplars 635 for the corresponding spatial region is greater than a threshold 660. At step 645, the method generates an output of spatial and temporal coordinates for an anomalous input video patch. At step 650, for each anomalous video patch, high-level attributes are computed from the high-level feature vector 627 for the anomalous video patch and the closest exemplar 635 using layers of the one or more neural networks 625 (as explained in FIG. 3) to provide explanation of cause of the anomaly. The cause may be due to dissimilarity of the high-level attributes from the input video patch and its closest matching exemplar. At step 655, the method 600 provides explanation of cause of the anomaly as a list of high-level attributes identified as anomaly causes.

In such a manner, some embodiments can provide an anomaly detector suitable for direct comparison of activities with practical computation and memory requirements suitable, e.g., for closed circuit television (CCTV) systems.

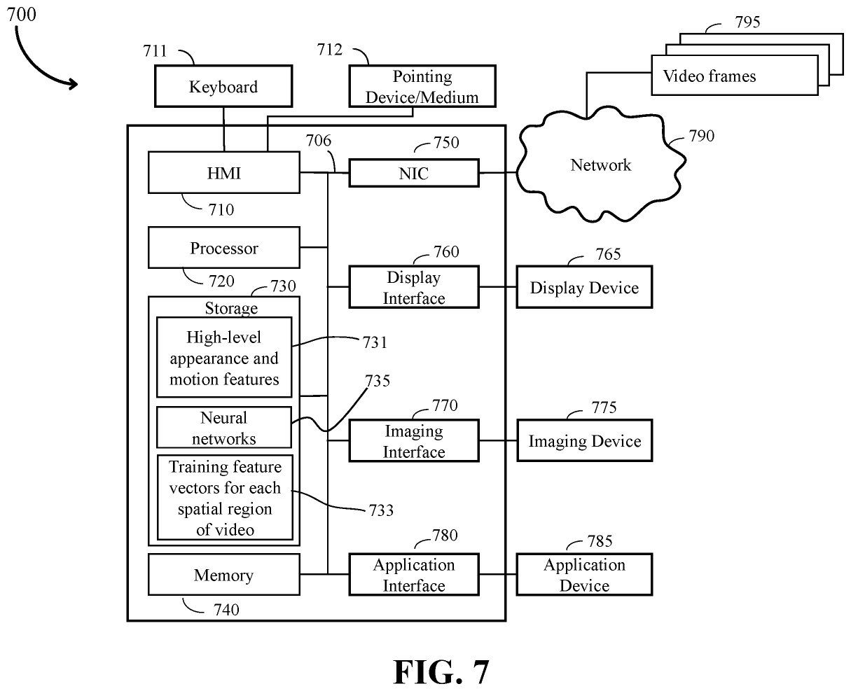

FIG. 7 illustrates a block diagram of a computer-based system 700 for detecting anomalies in an input video, in accordance with some embodiments. The computer-based system 700 includes a processor 720 configured to execute stored instructions, as well as a memory 740 that stores instructions that are executable by the processor 720. The processor 720 can be a single core processor, a multi-core processor, a computing cluster, or any number of other configurations. The memory 740 can include random access memory (RAM), read only memory (ROM), flash memory, or any other suitable memory systems. The processor 720 is connected through a bus 706 to one or more input and output devices. These instructions implement a method for detecting anomalies in a video sequence of video frames 795.

In various embodiments, the computer-based system 700 generates a set of bounding boxes indicating locations and sizes of any anomalies in each of the video frames 795. The computer-based system 700 is configured to detect anomalies in the input video. Firstly, the computer-based system partitions the video frames 795 into video patches with a fixed height, width and number of video frames and then uses neural networks 735 to estimate high-level appearance and motion features 731 (hereinafter high-level features) of each of the video patches. The high-level features 731 of the video patches of the input video are compared with stored high-level features of nominal video patches computed from nominal video of the same scene. An anomaly is declared for the input video patch when the high-level features 731 computed for that video patch are dissimilar to all of the high-level nominal features for the corresponding spatial region. Further, the computer-based system 700 is configured to provide an explanation. The explanation for an anomaly is based on the high-level features 731 of the input video patch that are not matched with the nearest nominal feature vectors. The explanation includes information about the cause of the anomaly.

In some implementations, a human machine interface (HMI) 710 within the computer-based system 700 connects the system 102 of FIG. 1A to a keyboard 711 and pointing device 712. The pointing device 712 includes but is not limited to a mouse, trackball, touchpad, joystick, pointing stick, stylus, or touchscreen, among others. The computer-based system 700 is linked through the bus 706 to a display interface 760 adapted to connect the computer-based system 700 to a display device 765. The display device 765 includes but is not limited to a computer monitor, camera, television, projector, or mobile device.

The computer-based system 700 can be connected to an imaging interface 70 adapted to connect the system 102 to an imaging device 775. In one embodiment, the video frames 795 of the input video on which the anomaly detection is performed are received from the imaging device 775. The imaging device 775 may include a video camera, computer, mobile device, webcam, or any combination thereof.

In some embodiments, the computer-based system 700 is connected to an application interface 780 through the bus 706 adapted to connect the computer-based system 700 to an application device 785. The application device 785 operates based on results of anomaly detection. In an example, the application device 785 is a surveillance system that uses the locations of detected anomalies to alert a security guard to investigate further.

A network interface controller 750 is adapted to connect the computer-based system 700 through the bus 706 to a network 790. Through the network 790, the video frames 795, for example, frames of the normal or nominal patches of video and/or input or testing patches of video are downloaded and stored within the computer's storage 730 for storage and/or further processing. In some embodiments, the nominal and input video patches are stored as a set of high-level features or a set of high-level attributes extracted from the corresponding video patches, for example input feature vectors (high-level appearance and motion features 731) or nominal feature vectors 733. In such a manner, the storage requirements can be reduced, while improving subsequent processing of the videos. Examples of high-level attributes extracted from the video may include classes of objects present in a video patch, directions of motion of the objects and speeds of motion of the objects (as explained above in FIG. 1B). High-level features may be internal features of a neural network that can be mapped to high-level attributes.

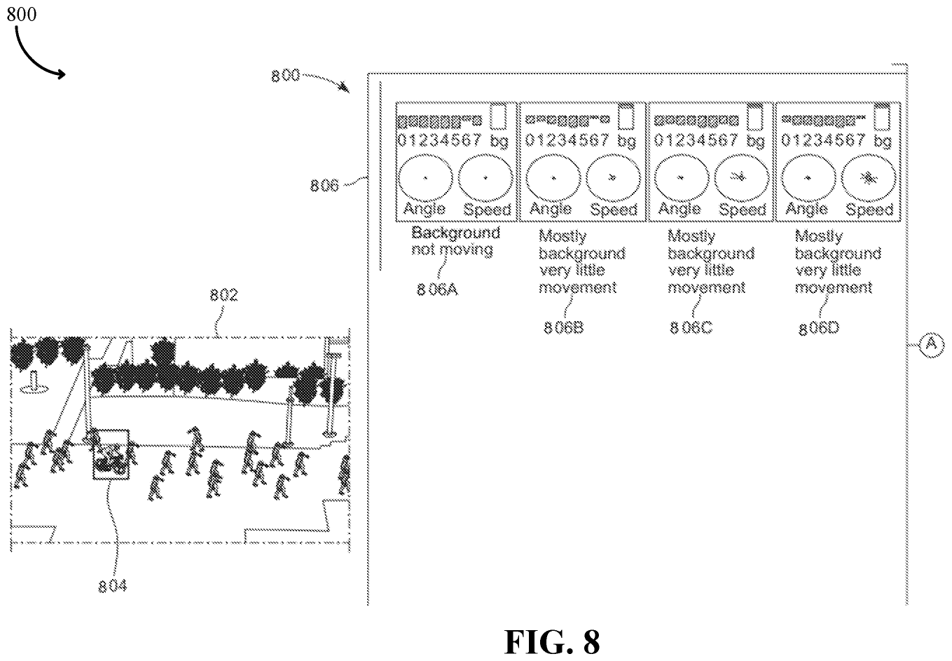

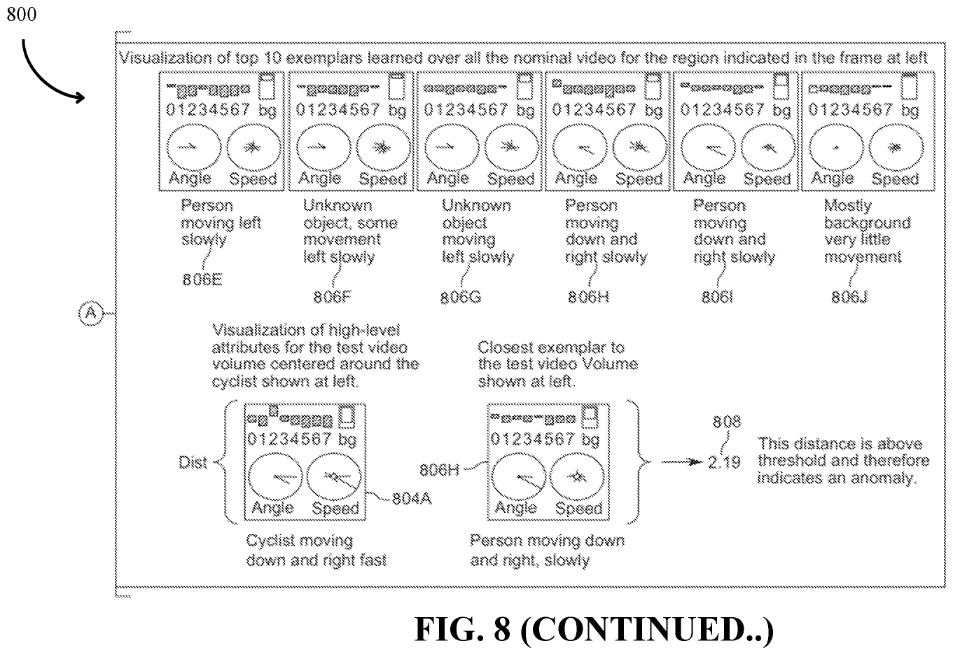

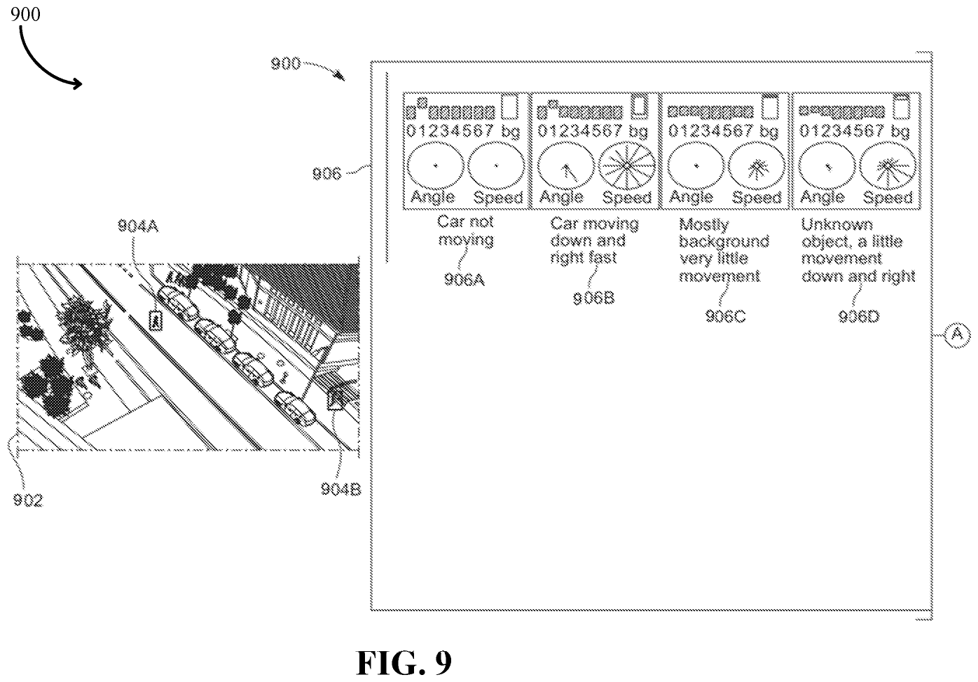

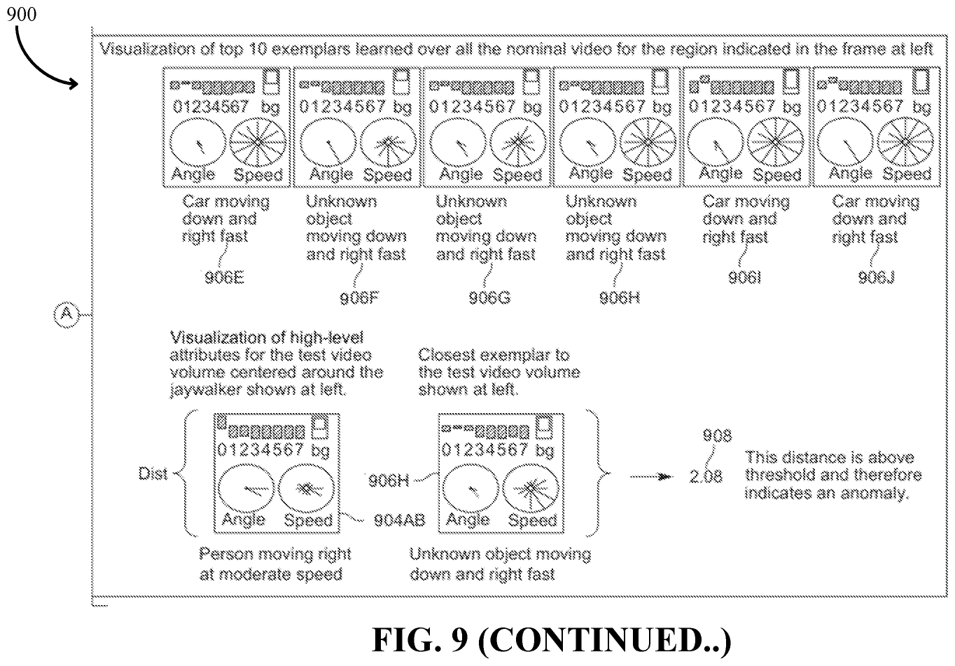

In an embodiment, the computer-based system 700 corresponds to the system 102 of FIG. 1B. In another embodiment, the computer-based system 700 is associated with the system 102. In yet another embodiment, the computer-based system 700 is a part of the system 102. Further, use cases of the system 102 are explained in FIG. 8 and FIG. 9.

FIG. 8 illustrates a use case 800 of the system 102, in accordance with some embodiments. The use case 800 includes a region 802 of a street scene and visualization of a plurality of exemplars 806 learned for the region 802 from nominal video of the same scene. The system 102 analyzes the region (test frame) 802 on a sidewalk of the street scene and extracts the plurality of exemplars 806 of the region 802. The region 802 is a spatial region. The plurality of exemplars 806 learned for the region 802 includes background with no movement 806A, background with very little movement 806B, 806C, and 806D, person moving mainly left at slow speed 806E, unknown object with some movement at left 806F, and 806G, person moving right and down at slow speeds 806H, and 806I, and mostly background with very little movement 806J. The plurality of exemplars 806 may not be limited to the mentioned examples.

For the test frame (the region 802) shown, a cyclist is riding on the sidewalk. A bounding box 804 indicates the cyclist on the sidewalk. The system 102 generates a visualization 804A of a video volume centered on the region 802. The visualization 804A shows that the region 802 includes the cyclist travelling down and right at a high speed in the sidewalk (a high level attribute). The system 102 maps the high level feature of the region 802 with the plurality of exemplars 806 (806A-806J). The system 102 indicates the exemplar 806H as the closest exemplar to the visualization 804A of the high level feature of the region 802. The exemplar 806H indicates a person moving down and right at a slow speed. In addition, the system 102 finds a distance 808 between the high level feature of the region 802 and the closest exemplar 806H. The distance 808 is about 2.19 which is greater than the threshold distance. In an example, if the distance 908 is greater than the threshold distance, the system 102 generates a high anomaly score for the region 802. This states that the region 802 is anomalous. Further, the system 102 provides explanation for the high anomaly score. The explanation may state that, “the closest exemplar 806H indicates a person moving down and right at a slow speed, but in the region 802, there is a cyclist instead of a person. Usually, at the sidewalk, there are no cyclists, hence the region 802 has the high anomaly score and is anomalous.”

FIG. 9 illustrates a use case 900 of the system 102, in accordance with some embodiments. The use case 900 includes a region 902 of a street scene and visualization of a plurality of exemplars 906 learned for the region 902. In addition, the use case 900 includes visualization 904AB of a test video volume of the region 902 explaining reason of anomaly detection in the region 902.

The region 902 shows cars travelling down and to the right in a lane of a street and jaywalkers 904A and 904B. The system 102 analyzes the region (test frame) 902 the street scene and extracts the plurality of exemplars 906 of the region 902. The region 902 is a spatial region. The plurality of exemplars 906 learned for the region 902 includes car not moving 906A (since occasionally traffic stops on this part of the street), car moving down and right at a fast speed 906B (as expected), mostly background with very little movement 906C, unknown object with a little movement down and right 906D, car moving down and right at a fast speed 906E, unknown object moving down and right at fast speed 906F, 906G, and 906H, and car moving down and right at fast speed 906I, and 906J. The plurality of exemplars 906 may not be limited to the mentioned examples.

Furthermore, one of the video volumes of the region 902 contains a person jaywalking (jaywalker 904A, 904B), and the system 102 generates a visualization 904AB of high-level features for the video volumes of the region 902 show the jaywalkers 904A, and 904B. The system maps the high-level features of with the plurality of exemplars 906. The closest exemplar to the video volume is the exemplar 906H that indicates an unknown object moving down and to the right. There is no exemplar that represents anything similar to a person walking to the right for the region 902. Further, the system 102 is configured to calculate a distance 908 between the high-level features of the region 902 and the closest exemplar 906H. Thus, the distance 908 to the nearest exemplar is high, indicating an anomaly. The distance 908 is equal to 2.08 which is higher than a threshold distance of 1.8. This states that the region 902 is anomalous. Further, the system 102 provides explanation for the detected anomaly. The explanation may state that, “the closest exemplar 906H indicates an unknown object moving down and right at a fast speed, but in the region 902, there are jaywalkers 904A and 904B instead of the unknown objects. Hence, due to the jaywalkers 904A, and 904B in a street lane, the anomaly is detected in the region 902.” The system 902 provides explanation about the anomaly detection that is human understandable.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The above-described embodiments of the present disclosure may be implemented in any of numerous ways. For example, the embodiments may be implemented using hardware, software or a combination thereof. When implemented in software, the software code may be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Also, the embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Therefore, it is the object of the appended claims to cover all such variations and modifications as come within the true spirit and scope of the present disclosure.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A system for video anomaly detection, comprising: a processor; and a memory having instructions stored thereon that, when executed by the processor, cause the system to:
collect a sequence of input video frames of an input video of a scene;
partition the sequence of input video frames into a plurality of input video patches, wherein each of the plurality of input video patches is a spatio-temporal patch;
process each of the plurality of input video patches with one or more classifiers, wherein each of the one or more classifiers corresponds to a deep neural network having an output layer trained to estimate one or more attributes of the plurality of input video patches from an output of a penultimate layer of the deep neural network;
compare the output of the penultimate layer of the one or more classifiers generated using the plurality of input video patches with nominal outputs of the penultimate layer of the one or more classifiers generated using a plurality of nominal video patches from corresponding spatial regions,
wherein the plurality of nominal video patches are extracted from nominal video of the scene
detect an anomaly when the output of the penultimate layers of the one or more classifiers for an input video patch is dissimilar to the outputs of the penultimate layers of the one or more classifiers for the plurality of nominal video patches from the same spatial region as the input video patch; and
providing an output comprising an explanation of a type of the detected anomaly, wherein the output is provided based on the one or more attributes of the input video patch estimated by the output layer of the one or more classifiers that are dissimilar to the attributes of the closest matching nominal video patch.

2. The system of claim 1, wherein each of the plurality of input video patches has a spatial dimension defining a spatial region of the spatio-temporal patch in each of the sequence of input video frames and a temporal dimension defining a number of input video frames forming the spatio-temporal patch.

3. The system of claim 1, wherein the plurality of nominal video patches are generated by partitioning one or more video frames of a nominal video present in a sequence of nominal video frames, wherein the nominal video corresponds to video of normal activities happening in the same scene as the input video.

4. The system of claim 3, wherein the plurality of nominal video patches for each spatial region are a subset of every possible video patch in the sequence of nominal video frames and are chosen to cover the entire set of nominal video patches.

5. The system of claim 1, wherein the spatio-temporal partitions of the input video are identical to the spatio-temporal partitions of the nominal video, wherein the identical spatio-temporal partitions are used to streamline the comparison.

6. The system of claim 1, wherein the one or more attributes of the input video patch comprises appearance and motion attributes, wherein the appearance and motion attributes comprises at least one of: directions of motion for objects in the input video patch, speed of motion in each direction, and size of moving objects in the input video patch.

7. The system of claim 1, wherein the deep neural network is trained using a sequence of video frames.

8. The system of claim 1, wherein the system is configured to compare the output generated by the penultimate layer of the one or more classifiers with the corresponding nominal outputs using one or more algorithms associated with nearest neighbor search, wherein the one or more algorithms corresponds to at least one of: brute force search, k-d trees, k-means trees, and locality sensitive hashing.

9. The system of claim 1, wherein the system is configured to calculate a distance between the one or more attributes of the input video and a closest matching attribute of a nominal video.

10. A computer-implemented method for performing video anomaly detection, comprising:
collecting a sequence of input video frames of an input video of a scene;
partitioning the sequence of input video frames into a plurality of input video patches, wherein each of the plurality of input video patches is a spatio-temporal patch defined in space and time;
processing each of the plurality of input video patches with one or more classifiers, wherein each of the one or more classifiers corresponds to a deep neural network having an output layer trained to estimate one or more attributes of the plurality of input video patches from an output of a penultimate layer of the deep neural network;
comparing the output of the penultimate layer of the one or more classifiers generated using the plurality of input video patches with corresponding nominal outputs of the penultimate layer of the one or more classifiers generated using a plurality of nominal video patches,
wherein the plurality of nominal video patches are extracted from nominal video of the scene;
detect an anomaly when the output of the penultimate layers of the one or more classifiers for an input video patch is dissimilar to the outputs of the penultimate layers of the one or more classifiers for the plurality of nominal video patches from the same spatial region as the input video patch; and
providing an output comprising an explanation of a type of the detected anomaly, wherein the output is provided based on the one or more attributes of the input video patch estimated by the output layer of the one or more classifiers that are dissimilar to the attributes of the closest matching nominal video patch.

11. The method of claim 10, wherein each of the plurality of input video patches is a spatio-temporal patch defined in space and time by a spatial dimension defining a spatial region of the spatio-temporal patch in each of the sequence of input video frames and a temporal dimension defining a number of input video frames forming the spatio-temporal patch.

12. The method of claim 10, wherein the nominal video patches are generated by partitioning one or more video frames of a nominal video present in a sequence of nominal video frames, wherein the nominal video corresponds to video of normal activities happening at one or more locations.

13. The method of claim 10, wherein the spatio-temporal partitions of the input video are identical to the spatio-temporal partitions of a nominal video, wherein the identical spatio-temporal patches are used to streamline the comparison.

14. The method of claim 10, wherein the one or more attributes of the input video patch comprises at least one of: appearance and motion attributes, such as directions of motion for objects in the input video patch, speed of motion in each direction, and size of moving objects in the input video patch.

15. The method of claim 10, wherein the deep neural network is trained using a sequence of nominal video frames.

16. The method of claim 10, wherein the system is configured to compare the output generated by the penultimate layer of the one or more classifiers with the corresponding nominal outputs using one or more algorithms associated with nearest neighbor search, wherein the one or more algorithms corresponds to at least one of: brute force search, k-d trees, k-means trees, and locality sensitive hashing.
